(19) United States
(12) Patent Application Publication
(10) Pub. No.: US 2025/0206857 A1
(43) Pub. Date: Jun. 26, 2025

(54) POLYMER COMPOSITION AND USE THEREOF AS SILANOL CONDENSATION CATALYST MASTERBATCH

(71) Applicant: BOREALIS AG, Vienna (AT)

(72) Inventors: Lena Lindbom, Stenungsund (SE); Tina Gschneidtner, Stenungsund (SE); Bernt-Åke Sultan, Lidköping (SE); Tua Sundholm, Porvoo (FI); Paulo Almeida, Mechelen (BE); Ann Watson, Woodville, Arbroath (GB); Andrei Ollikainen, Kullo (FI)

(21) Appl. No.: 18/848,191

(22) PCT Filed: Mar. 22, 2023
(86) PCT No.: PCT/EP2023/057297

§ 371 Date: Sep. 18, 2024

(30) Foreign Application Priority Data
Mar. 24, 2022 (EP) 22164010.5

(51) Int. Cl. C08F 110/02; C08J 3/22; C08K 5/5419; C08L 23/0869

(52) U.S. Cl. CPC C08F 110/02; C08J 3/226; C08K 5/5419; C08L 23/0869; C08J 2323/06; C08J 2323/08; C08L 2201/02; C08L 2203/202; C08L 2207/066; C08L 2312/08

(57) ABSTRACT

The invention relates to a polymer composition (PC) comprising (a) a polyethylene (PE), which does not contain hydrolysable silane groups, (b) an ethylene (meth)acrylate copolymer (EAC), (c) a silanol condensation catalyst (SCC), and (d) a scorch retardant additive (SRA). The invention further relates to use of said polymer composition (PC) as a masterbatch for the preparation of cross-linkable polymer compositions, to said cross-linkable polymer compositions, and to articles comprising said cross-linkable polymer compositions.

### TECHNICAL FIELD

The present invention relates to a polymer composition comprising a silanol condensation catalyst and the use of such a composition as a masterbatch in the preparation of a cross-linkable polymer composition. The invention further relates to cross-linkable polymer compositions with hydrolysable silane groups as well as articles made by cross-linking polymer compositions such as, but not limited to, a cable.

### BACKGROUND

In wire and cable applications, a typical cable comprises a conductor which is surrounded by one or more layers of polymeric materials. One or more of said layers of polymeric materials are often cross-linked to improve mechanical strength, heat resistance and chemical resistance of the cable, and the like. For this purpose, cross-linkable polymer compositions are used which are usually based on a polyolefin which contains a cross-linkable group, such as hydrolysable silane groups. The hydrolysable silane groups can react with water to provide silanol groups which subsequently cross-link with one another to provide a cross-linked polymer composition. A process which is also known in the art as moisture curing.

To start and/or accelerate cross-linking of silanol groups, a silanol condensation catalyst such as a sulfonic acid can be used. The silanol condensation catalyst is usually provided together with a polymeric carrier resin in form of a polymer masterbatch. The polymer masterbatch can comprise further additives, and particularly polar additives like scorch retarders and antioxidants.

Known silanol condensation catalyst masterbatches are either based on unpolar carrier resins such as a polyolefin or on polar carrier resins such as ethylene acrylates. In both cases, there are certain technical drawbacks, for example, when used in conjunction with a cross-linkable polyolefin. Masterbatches based on unpolar carrier resins are intrinsically limited with regard to the amounts of polar additives which can be included therein. Insufficient amounts of polar additives can in turn negatively effect end properties of an article such as stability and/or surface finishing. On the other hand, the use of masterbatches based on polar carrier resins can lead to radial shrinkage of the cross-linked polymer composition. As far as cable applications are concerned, radial shrinkage of a cross-linked polymer composition may lead to handling problems such as loose cable on the cable drum.

EP 0736065 B1 relates to a crosslinkable polymer composition containing a crosslinkable polymer with hydrolysable silane groups and at least one silanol condensation catalyst. The silanol condensation catalyst is a compound of the formula ArSO₃H or a precursor thereof, Ar being a substituted benzene or naphthalene ring, the substituent or substituents containing 4-20 carbon atoms, preferably 10-18 carbon atoms.

WO 2007/137757 A1 relates to a composition comprising (i) a crosslinkable polyolefin with hydrolysable silane groups, (ii) a Bronsted acid as a silanol condensation catalyst, and (iii) a silicon containing compound according to the formula (I) as defined in the abstract of WO 2007/137757 A1.

There is a need in the art for improved polymer compositions comprising a silanol condensation catalyst.

### SUMMARY OF INVENTION

In one aspect, the invention provides a polymer composition (PC) comprising
(a) a polyethylene (PE), which does not contain hydrolysable silane groups,
(b) an ethylene (meth)acrylate copolymer (EAC),
(c) a silanol condensation catalyst (SCC), and
(d) a scorch retardant additive (SRA).

The present invention is based on the inventors finding that a polymer composition comprising a silanol condensation catalyst, at least one additive which is a scorch retarder and a blend of a polyethylene and an ethylene (meth)acrylate copolymer is useful as a silanol condensation catalyst masterbatch. In particular, it has been found that the use of the polymer composition according to the invention mitigates radial shrinkage of a final cross-linked article while maintaining important end properties thereof such as stability and/or surface finishing.

Where the term “comprising” is used in the present description and claims, it does not exclude other non-specified elements of major or minor functional importance. For the purposes of the present invention, the term “essentially consisting of” and “consisting of” are considered to be specific embodiments of the term “comprising of”. If hereinafter a group is defined to comprise at least a certain number of features or embodiments, this is also to be understood to disclose a group, which optionally essentially consists only of these features or embodiments or consists only of these features or embodiments. Whenever the terms “including” or “having” are used, these terms are meant to be equivalent to “comprising” as defined above.

The term “(meth)acrylate” as used herein encompasses methacrylate and acrylate.

In another aspect, the invention provides the use of a polymer composition (PC) as defined herein as a silanol condensation catalyst masterbatch for the preparation of a cross-linkable polymer composition.

In still another aspect, the invention provides a cross-linkable polymer composition (CL-PC) comprising
(i) the polymer composition (PC) as defined herein, and
(ii) a cross-linkable polyolefin (CL-PO) which comprises hydrolysable silane groups.

In yet another aspect, the invention provides an article comprising the cross-linkable polymer composition (CL-PC) as defined herein, and preferably wherein the cross-linkable polymer composition (CL-PC) is cross-linked.

Preferred embodiments of the invention are defined in the sub claims.

According to one embodiment, the polymer composition (PC) comprises the polyethylene (PE) and the ethylene (meth)acrylate copolymer (EAC) in a weight ratio of 95:5 to 20:80, preferably in a weight ratio 94:6 to 20:80, more preferably in a weight ratio of 92:8 to 40:60, even more preferably in a weight ratio of 80:20 to 40:60, and yet even more preferably in a weight ratio of 70:30 to 40:60.

According to one embodiment, the polymer composition (PC) comprises
(a) 30.0 to 94.0 wt. %, preferably 40.0 to 85.0 wt. %, more preferably 41.0 to 83.0 wt. %, and still more preferably 42.0 to 80.0 wt. %, of the polyethylene (PE),
(b) 5.0 to 60.0 wt. %, preferably 8.0 to 55.0 wt. %, more preferably 8.0 to 50.0 wt. %, and still more preferably 9.0 to 45.0 wt. %, of the ethylene (meth)acrylate copolymer (EAC),
(c) 0.5 to 8.0 wt. %, preferably 0.8 to 6.0 wt. %, more preferably 1.0 to 4.0 wt. %, and still more preferably 1.0 to 2.0 wt. %, of the silanol condensation catalyst (SCC), and
(d) 0.5 to 5.0 wt. %, preferably 1.0 to 4.5 wt. %, more preferably 1.5 to 4.0 wt. %, and still more preferably 2.0 to 3.5 wt. %, of the scorch retardant additive (SRA), and
(e) optionally 0.1 to 8.0 wt. %, preferably 0.5 to 7.0 wt. %, more preferably 3.0 to 7.0 wt. %, and still more preferably 4.0 to 6.5 wt. %, of an antioxidant (AO),
(f) optionally 0.1 to 5.0 wt. %, preferably 0.1 to 4.0 wt. %, more preferably 0.1 to 3.0 wt. %, and still more preferably 0.1 to 2.0 wt. % of additional additives (AD-1), wherein all weight contents are based on the total weight of the polymer composition (PC), and optionally wherein the components (a) to (f) add up to 100 wt. %.

According to one embodiment, the polyethylene (PE) is a low density polyethylene (LDPE), and/or the polyethylene (PE) is a polyethylene homopolymer.

According to one embodiment, the ethylene (meth)acrylate copolymer (EAC) is a copolymer of ethylene and at least one comonomer selected from C1-C6 hydrocarbyl (meth)acrylates, preferably is a copolymer of ethylene and at least one comonomer selected from C1-C6 hydrocarbyl acrylates, and more preferably is a copolymer of ethylene and one comonomer selected from C1-C6 hydrocarbyl acrylates.

According to one embodiment, the ethylene (meth)acrylate copolymer (EAC) has a (meth)acrylate comonomer content in the range of 5.0 to 25.0 wt. %, preferably 10.0 to 21.0 wt. %, and more preferably 15.0 to 19.0 wt. %, based on the total weight of the ethylene (meth)acrylate copolymer (EAC).

According to one embodiment, the silanol condensation catalyst (SCC) is a sulfonic acid.

According to one embodiment, the silanol condensation catalyst (SCC) is a sulfonic acid of the formula (SSC-1) or a precursor thereof:

Ar(SO₂OH)x (SSC-1),
wherein
Ar is an aryl group, which is optionally substituted by at least one optionally substituted C1-C₃₀-hydrocarbyl group, and
x is at least 1.

According to one embodiment, the scorch retardant additive (SRA) is an organic silane comprising at least one Si—O bond.

According to one embodiment, the scorch retardant additive (SRA) is a silane of the formula (SRA-1):

Si(R¹)n(R²)m (SRA-1),
wherein
n is 1 to 3 and m is 1 to 3 with the proviso that n+m=4,
R¹ is an optionally substituted C5-C30 alkyl group, or, if n is more than 1, is each independently an optionally substituted C5-C30 alkyl group,
R² is an optionally substituted C1-C6 alkoxy group, or, if m is more than 1, is each independently an optionally substituted C1-C6 alkoxy group.

According to one embodiment, the polymer composition (PC) has an aggregation rating determined according to the method described herein under “Method—aggregation test” of at least 3 after 3 months of storage at 50° C. and a relative humidity of 50%.

According to one embodiment, the article is a cable.

In the following, the present invention is described in more detail.

### DETAILED DESCRIPTION

### Polymer Composition (PC)

One aspect of the invention provides a polymer composition (PC). The polymer composition (PC) comprises
(a) a polyethylene (PE), wherein the polyethylene (PE) does not contain hydrolysable silane groups,
(b) an ethylene (meth)acrylate copolymer (EAC),
(c) a silanol condensation catalyst (SCC), and
(d) a scorch retardant additive (SRA).

The polymer composition (PC) preferably comprises the polyethylene (PE) and the ethylene (meth)acrylate copolymer (EAC) in specific weight ratios. According to one embodiment, the polymer composition (PC) comprises the polyethylene (PE) and the ethylene (meth)acrylate copolymer (EAC) in a weight ratio of 95:5 to 5:95, preferably in a weight ratio 94:6 to 20:80, more preferably in a weight ratio of 92:8 to 40:60, even more preferably in a weight ratio of 80:20 to 40:60, and yet even more preferably in a weight ratio of 70:30 to 40:60, like a weight ratio of 65:30 to 45:55.

According to one embodiment, the polymer composition (PC) comprises
(a) 30.0 to 94.0 wt. %, preferably 40.0 to 85.0 wt. %, more preferably 41.0 to 83.0 wt. %, and still more preferably 42.0 to 80.0 wt. % of the polyethylene (PE),
(b) 5.0 to 60.0 wt. %, preferably 8.0 to 55.0 wt. %, more preferably 8.0 to 50.0 wt. %, and still more preferably 9.0 to 45.0 wt. % of the ethylene (meth)acrylate copolymer (EAC),
(c) 0.5 to 8.0 wt. %, preferably 0.8 to 6.0 wt. %, more preferably 1.0 to 4.0 wt. %, and still more preferably 1.0 to 2.0 wt. % of the silanol condensation catalyst (SCC), and
(d) 0.5 to 5.0 wt. %, preferably 1.0 to 4.5 wt. %, more preferably 1.5 to 4.0 wt. %, and still more preferably 2.0 to 3.5 wt. %, of the scorch retardant additive (SRA),
   wherein all weight contents are based on the total weight of the polymer composition (PC).

According to one embodiment, the polymer composition (PC) comprises
(a) 30.0 to 94.0 wt. %, preferably 40.0 to 90.2 wt. %, more preferably 41.0 to 89.5 wt. %, and still more preferably 42.0 to 88.0 wt. % of the polyethylene (PE),
(b) 5.0 to 60.0 wt. %, preferably 8.0 to 55.0 wt. %, more preferably 8.0 to 50.0 wt. %, and still more preferably 9.0 to 45.0 wt. % of the ethylene (meth)acrylate copolymer (EAC),
(c) 0.5 to 8.0 wt. %, preferably 0.8 to 6.0 wt. %, more preferably 1.0 to 4.0 wt. %, and still more preferably 1.0 to 2.0 wt. % of the silanol condensation catalyst (SCC), and
(d) 0.5 to 5.0 wt. %, preferably 1.0 to 4.5 wt.-%, more preferably 1.5 to 4.0 wt. %, and still more preferably 2.0 to 3.5 wt. %, of the scorch retardant additive (SRA),
   wherein all weight contents are based on the total weight of the polymer composition (PC).

The polymer composition (C) optionally comprises an antioxidant (AO) as additional component (e).

According to one embodiment, the polymer composition (PC) comprises
(a) 30.0 to 94.0 wt. %, preferably 40.0 to 85.0 wt. %, more preferably 41.0 to 83.0 wt. %, and still more preferably 42.0 to 80.0 wt. %, of the polyethylene (PE),
(b) 5.0 to 60.0 wt. %, preferably 8.0 to 55.0 wt. %, more preferably 8.0 to 50.0 wt. %, and still more preferably 9.0 to 45.0 wt. %, of the ethylene (meth)acrylate copolymer (EAC),
(c) 0.5 to 8.0 wt. %, preferably 0.8 to 6.0 wt. %, more preferably 1.0 to 4.0 wt. %, and still more preferably 1.0 to 2.0 wt. %, of the silanol condensation catalyst (SCC), and
(d) 0.5 to 5.0 wt. %, preferably 1.0 to 4.5 wt. %, more preferably 1.5 to 4.0 wt. %, and still more preferably 2.0 to 3.5 wt. %, of the scorch retardant additive (SRA),
(e) optionally 0.1 to 8.0 wt. %, preferably 0.5 to 7.0 wt. %, more preferably 3.0 to 7.0 wt. %, and still more preferably 4.0 to 6.5 wt. %, of an antioxidant (AO), wherein all weight contents are based on the total weight of the polymer composition (PC).

It is preferred that the polymer composition (PC) comprises an antioxidant (AO) as a component (e). Hence, according to one preferred embodiment, the polymer composition (PC) comprises,
(a) 30.0 to 93.9 wt. %, preferably 40.0 to 85.0 wt. %, more preferably 41.0 to 83.0 wt. %, and still more preferably 42.0 to 80.0 wt. % of the polyethylene (PE),
(b) 5.0 to 60.0 wt. %, preferably 8.0 to 55.0 wt. %, more preferably 8.0 to 50.0 wt. %, and still more preferably 9.0 to 45.0 wt. % of the ethylene (meth)acrylate copolymer (EAC),
(c) 0.5 to 8.0 wt. %, preferably 0.8 to 6.0 wt. %, more preferably 1.0 to 4.0 wt. %, and still more preferably 1.0 to 2.0 wt. % of the silanol condensation catalyst (SCC), and
(d) 0.5 to 5.0 wt. %, preferably 1.0 to 4.5 wt. %, more preferably 1.5 to 4.0 wt. %, and still more preferably 2.0 to 3.5 wt. %, of the scorch retardant additive (SRA),
(e) 0.1 to 8.0 wt. %, preferably 0.5 to 7.0 wt. %, more preferably 3.0 to 7.0 wt. %, and still more preferably 4.0 to 6.5 wt. %, of an antioxidant (AO), wherein all weight contents are based on the total weight of the polymer composition (PC).

According to one preferred embodiment, the polymer composition (PC) comprises, preferably consists of,
(a) 30.0 to 93.9 wt. %, preferably 40.0 to 85.0 wt. %, more preferably 41.0 to 83.0 wt. %, and still more preferably 42.0 to 80.0 wt. % of the polyethylene (PE),
(b) 5.0 to 60.0 wt. %, preferably 8.0 to 55.0 wt. %, more preferably 8.0 to 50.0 wt. %, and still more preferably 9.0 to 45.0 wt. % of the ethylene (meth)acrylate copolymer (EAC),
(c) 0.5 to 8.0 wt. %, preferably 0.8 to 6.0 wt. %, more preferably 1.0 to 4.0 wt. %, and still more preferably 1.0 to 2.0 wt. % of the silanol condensation catalyst (SCC), and
(d) 0.5 to 5.0 wt. %, preferably 1.0 to 4.5 wt. %, more preferably 1.5 to 4.0 wt. %, and still more preferably 2.0 to 3.5 wt. %, of the scorch retardant additive (SRA),
(e) 0.1 to 8.0 wt. %, preferably 0.5 to 7.0 wt. %, more preferably 3.0 to 7.0 wt. %, and still more preferably 4.0 to 6.5 wt. %, of an antioxidant (AO), wherein all weight contents are based on the total weight of the polymer composition (PC), and wherein the components (a) to (e) add up to 100 wt. %.

In one specific embodiment, the polymer composition (PC) comprises, preferably consists of,
(a) 35.0 to 70.0 wt. % of the polyethylene (PE),
(b) 20.0 to 55.0 wt. % of the ethylene (meth)acrylate copolymer (EAC),
(c) 1.0 to 4.0 wt. % of the silanol condensation catalyst (SCC), and
(d) 1.5 to 4.0 wt. % of the scorch retardant additive (SRA),
(e) 3.0 to 8.0 wt. % of an antioxidant (AO), wherein all weight contents are based on the total weight of the polymer composition (PC), and wherein the components (a) to (e) add up to 100 wt. %.

It is further possible that the polymer composition comprises one or more additional additives (AD-1) as component(s) (f). Hence, according to one preferred embodiment, the polymer composition (PC) comprises, preferably consists of,
(a) 30.0 to 93.8 wt. %, preferably 40.0 to 85.0 wt. %, more preferably 41.0 to 83.0 wt. %, and still more preferably 42.0 to 80.0 wt. % of the polyethylene (PE),
(b) 5.0 to 60.0 wt. %, preferably 8.0 to 55.0 wt. %, more preferably 8.0 to 50.0 wt. %, and still more preferably 9.0 to 45.0 wt. % of the ethylene (meth)acrylate copolymer (EAC),
(c) 0.5 to 8.0 wt. %, preferably 0.8 to 6.0 wt. %, more preferably 1.0 to 4.0 wt. %, and still more preferably 1.0 to 2.0 wt. % of the silanol condensation catalyst (SCC), and
(d) 0.5 to 5.0 wt. %, preferably 1.0 to 4.5 wt. %, more preferably 1.5 to 4.0 wt. %, and still more preferably 2.0 to 3.5 wt. %, of the scorch retardant additive (SRA),
(e) 0.1 to 8.0 wt. %, preferably 0.5 to 7.0 wt. %, more preferably 3.0 to 7.0 wt. %, and still more preferably 4.0 to 6.5 wt. %, of an antioxidant (AO),
(f) 0.1 to 5.0 wt. %, preferably 0.1 to 4.0 wt. %, more preferably 0.1 to 3.0 wt. %, and still more preferably 0.1 to 2.0 wt. % of one or more additional additives (AD-1),
   wherein all weight contents are based on the total weight of the polymer composition (PC), and preferably wherein the components (a) to (f) add up to 100 wt. %.

In one specific embodiment, the polymer composition (PC) comprises, preferably consists of,
(a) 35.0 to 70.0 wt. % of the polyethylene (PE),
(b) 20.0 to 55.0 wt. % of the ethylene (meth)acrylate copolymer (EAC),
(c) 1.0 to 4.0 wt. % of the silanol condensation catalyst (SCC), and
(d) 1.5 to 4.0 wt. % of the scorch retardant additive (SRA),
(e) 3.0 to 8.0 wt. % of an antioxidant (AO),
(f) 0.1 to 2.0 wt. % of one or more additional additives (AD-1),
   wherein all weight contents are based on the total weight of the polymer composition (PC), and wherein the components (a) to (f) add up to 100 wt. %.

Preferably, the polymer composition (PC) of the invention does not comprise further polymer(s) different to the polyethylene (PE) and the ethylene (meth)acrylate copolymer (EAC) in an amount exceeding 5.0 wt. %, preferably in an amount exceeding 3.0 wt. %, more preferably in an amount exceeding 2.5 wt. %, based on the total weight of the polymer composition (PC).

The polymer composition (PC) can be provided in form of pellets. The polymer composition (PC) can have specific material properties.

For example, the polymer composition (PC) can have a melt flow rate MFR₂ (ISO1133; 190° C.; 2.16 kg) in the range of 10.0 to 30.0 g/10 min, preferably in the range of 15.0 to 25.0 g/10 min, and more preferably in the range of 16.0 to 20.0 g/10 min.

Furthermore, the polymer composition (PC) can have specific aggregation properties.

The aggregation rating as used herein has a rating scale from 1 to 5, wherein a rating of 1 indicates that a pelletized polymer composition (PC) shows much aggregation (i.e. the worst rating; all pellets form a lump and no pellets are freely flowing; cf. FIG. 2), and wherein a rating of 5 indicates that a pelletized polymer composition (PC) shows no or little aggregation (i.e. the best rating). According to one embodiment, the polymer composition (PC) has an aggregation rating determined according to the method described herein under “Method—aggregation test” of at least 3 after 3 months of storage at 50° C. and a relative humidity of 50%.

### Polyethylene (PE)

The polymer composition (PC) comprises a polyethylene (PE) as a component (a).

The polyethylene (PE) can, for example, be present in the polymer composition (PC) in an amount in the range of 30.0 to 94.0 wt. %, preferably 40.0 to 85.0 wt. %, more preferably 41.0 to 83.0 wt. %, and still more preferably 42.0 to 80.0 wt. %, based on the total weight of the polymer composition (PC).

The polyethylene (PE) does not contain hydrolysable silane groups. This can be understood in that the polyethylene (PE) does not contain more than 0.01 wt. % of hydrolysable silane groups, and preferably is essentially free of hydrolysable silane groups, and more preferably is completely free of hydrolysable silane groups.

Hydrolysable silane groups are known to the skilled person. A “hydrolysable silane group” in the meaning of the invention can be understood as an organic silane which has at least one Si—N and/or at least one Si—O bond.

According to one embodiment, the hydrolysable silane group is a silane group of the formula (Si):

(R^{a})₃Si—X^{a} (Si),
wherein R^{a} is any substituent and X^{a} is —O—R^{b}, —O—C(O)—R^{b} or —N—R^{b}, wherein R^{b} is an optionally substituted hydrocarbyl substituent.

Thus, the polyethylene (PE) is not (i) a copolymer of ethylene and a comonomer, which is an ethylenically unsaturated hydrolysable silane, or (ii) a polyethylene which has been grafted with an ethylenically unsaturated hydrolysable silane.

The polyethylene (PE) can be any polyethylene which is suitable for being mixed, e.g. melt-mixed, with the components (b) to (d) of the polymer composition (PC).

The polyethylene (PE) can be a homo- or copolymer of ethylene. Preferably the polyethylene is a polyethylene homopolymer. The expression “polyethylene homopolymer” as used herein relates to a polyethylene that consists substantially, i.e. of at least 99.0 wt. %, more preferably of at least 99.5 wt. %, still more preferably of at least 99.8 wt. %, like of at least 99.9 wt. %, of ethylene units. In another embodiment only ethylene units are detectable, i.e. only ethylene has been polymerized.

The polyethylene (PE) is preferably a low density polyethylene (LDPE). According to one embodiment, the low density polyethylene (LDPE) has a density in the range of 910 to 930 kg/m³, preferably in a range of 915 to 925 kg/m³, like in a range of 918 to 922 kg/m³ (e.g. about 920 kg/m³). According to one preferred embodiment, the polyethylene (PE) is a low density polyethylene homopolymer.

The melt flow rate (MFR) of the polyethylene (PE) can be in the range of 0.5 to 20.0 g/10 min (according to ISO1133; 190° C.; 2.16 kg), preferably in the range of 2.5 to 15.0 g/10 min, more preferably in the range of 5.0 to 10.0 g/10 min, like in the range of 6.0 to 8.0 g/10 min.

According to one preferred embodiment, the polyethylene (PE) is a low density polyethylene (LDPE) homopolymer having a melt flow rate in the range of 0.5 to 20.0 g/10 min (according to ISO1133; 190° C.; 2.16 kg), preferably in the range of 2.5 to 15.0 g/10 min, more preferably in the range of 5.0 to 10.0 g/10 min, like in the range of 6.0 to 8.0 g/10 min.

### Ethylene (Meth)Acrylate Copolymer (EAC)

The polymer composition (PC) comprises an ethylene (meth)acrylate copolymer (EAC) as a component (b). Preferably, the ethylene (meth)acrylate copolymer (EAC) is an ethylene acrylate copolymer.

The ethylene (meth)acrylate copolymer (EAC) can, for example, be present in the polymer composition (PC) in an amount in the range of 5.0 to 60.0 wt. %, preferably 8.0 to 55.0 wt. %, more preferably 8.0 to 50.0 wt. %, and still more preferably 9.0 to 45.0 wt. %, based on the total weight of the polymer composition (PC).

The ethylene (meth)acrylate copolymer (EAC) is a polymer which is derived from ethylene and at least one (meth)acrylate comonomer, and optionally at least one additional comonomer which is not ethylene or an (meth)acrylate comonomer. According to one preferred embodiment, the ethylene (meth)acrylate copolymer (EAC) is a polymer which is derived from ethylene and at least one (meth)acrylate comonomer.

In case the ethylene (meth)acrylate copolymer (EAC) is a polymer which is derived from ethylene and more than one (meth)acrylate comonomers, the more than one (meth)acrylate comonomers can be independently selected from the group consisting of methacrylates and acrylates. It is preferred that the ethylene (meth)acrylate copolymer (EAC) is a polymer which is derived from ethylene and one (meth)acrylate comonomer, and more preferably one acrylate comonomer.

The at least one (meth)acrylate comonomer can be selected from C1-C12 hydrocarbyl (meth)acrylates, more preferably C1-C6 hydrocarbyl (meth)acrylates, like C1-C6 straight chain hydrocarbyl (meth)acrylates.

It is preferred that the at least one (meth)acrylate comonomer is at least one acrylate comonomer. The at least one acrylate comonomer is preferably selected from C1-C12 hydrocarbyl acrylates, more preferably C1-C6 hydrocarbyl acrylates, like C1-C6 straight chain hydrocarbyl acrylates. Thus, in one more preferred embodiment, the ethylene (meth)acrylate copolymer (EAC) is a polymer which is derived from ethylene and at least one acrylate comonomer, which is selected from C1-C12 hydrocarbyl acrylates, more preferably C1-C6 hydrocarbyl acrylates, like C1-C6 straight chain hydrocarbyl acrylates.

More preferably, the at least one acrylate comonomer is selected from C1-C12 alkyl acrylates, even more preferably C1-C6 alkyl acrylates, like C1-C6 straight chain alkyl acrylates. For example, the at least one acrylate comonomer can be a methyl, ethyl or butyl acrylate. The butyl acrylate can be branched or straight chain butyl, and preferably is n-butyl. Hence, according to one specific embodiment, the ethylene (meth)acrylate copolymer (EAC) is an ethylene butyl acrylate copolymer (EBA), like ethylene n-butyl acrylate copolymer (EBA).

The ethylene (meth)acrylate copolymer (EAC) can have a (meth)acrylate comonomer content, and preferably an acrylate comonomer content, in the range of 5.0 to 25.0 wt. %, preferably 10.0 to 21.0 wt. %, and more preferably 15.0 to 19.0 wt. %, based on the total weight of the ethylene (meth)acrylate copolymer (EAC). In one specific embodiment, the ethylene (meth)acrylate copolymer (EAC) has an (meth)acrylate comonomer content, and preferably an acrylate comonomer content, of about 17 wt. %, based on the total weight of the ethylene (meth)acrylate copolymer (EAC).

According to one embodiment, the ethylene (meth)acrylate copolymer (EAC) has a density in the range of 910 to 940 kg/m³, preferably in a range of 915 to 935 kg/m³, more preferably in a range of 920 to 930 kg/m³, like in a range of 922 to 928 kg/m³.

The melt flow rate (MFR) of the ethylene (meth)acrylate copolymer (EAC) can be in the range of 0.5 to 20.0 g/10 min (according to ISO1133; 190° C.; 2.16 kg), preferably in the range of 2.5 to 15.0 g/10 min, more preferably in the range of 5.0 to 10.0 g/10 min, like in the range of 6.0 to 9.0 g/10 min.

According to one preferred embodiment, the ethylene (meth)acrylate copolymer (EAC) has a melt flow rate in the range of 0.5 to 20.0 g/10 min (according to ISO1133; 190° C.; 2.16 kg), preferably in the range of 2.5 to 15.0 g/10 min, more preferably in the range of 5.0 to 10.0 g/10 min, like in the range of 6.0 to 8.0 g/10 min, and a density in the range of 910 to 940 kg/m³, preferably in a range of 915 to 935 kg/m³, more preferably in a range of 920 to 930 kg/m³, like in a range of 922 to 928 kg/m³.

### Silanol Condensation Catalyst (SCC)

The polymer composition (PC) comprises a silanol condensation catalyst (SCC) as a component (c).

The silanol condensation catalyst (SCC) can, for example, be present in the polymer composition (PC) in an amount in the range of 0.5 to 8.0 wt. %, preferably 0.8 to 6.0 wt. %, more preferably 1.0 to 4.0 wt. %, and still more preferably 1.0 to 2.0 wt. %, based on the total weight of the polymer composition (PC).

Silanol condensation catalysts are known in the art. Silanol condensation catalysts can accelerate hydrolysis of hydrolysable silane groups and/or accelerate cross-linking of hydrolysed silane groups which are part of a cross-linkable polymer.

Conventional silanol condensation catalysts are for example tin-organic compounds such as dibutyl tin dilaurate (DBTDL). It is further known that the cross-linking process advantageously is carried out in the presence of acidic silanol condensation catalysts. In contrast to the conventional tin-organic catalysts the acidic catalysts allow cross-linking to quickly take place already at room temperature. Such acidic silanol condensation catalysts are disclosed for example in WO 95/17463. The content of this document is enclosed herein by reference.

According to one embodiment, the silanol condensation catalyst (SCC) is an acidic silanol condensation catalyst (SCC). Examples for acidic silanol condensation catalysts comprise Lewis acids, inorganic acids such as sulfuric acid and hydrochloric acid, and organic acids such as citric acid, stearic acid, acetic acid, sulfonic acid and alkanoic acids such as dodecanoic acid. Preferred examples for an acidic silanol condensation catalyst are sulfonic acids and tin organic compounds.

According to one preferred embodiment, the silanol condensation catalyst is an organic acid, and is optionally selected from carboxylic acids, sulfonic acids, acidic alcohols, and mixtures thereof. According to one more preferred embodiment, the silanol condensation catalyst (SCC) is a sulfonic acid, i.e. a compound of the general formula R—S(O)₂OH, wherein R is an organic substituent.

The sulfonic acid is preferably an optionally substituted alkyl sulfonic acid or an optionally substituted aryl sulfonic acid, and preferably a hydrocarbyl substituted aryl sulfonic acid. The sulfonic acid can comprise one or more sulfonic acid groups.

According to one embodiment, the silanol condensation catalyst (SCC) is a sulfonic acid of the formula (SSC-1) or a precursor thereof:

Ar(SO₂OH)x (SSC-1),
wherein
Ar is an aryl group, which is optionally substituted by at least one hydrocarbyl group (e.g. one to four hydrocarbyl groups), and
x is at least 1 (e.g. 1 to 3).

The silanol condensation catalyst (SCC) may comprise the structural unit according to formula (SCC-1) one or several times, for example two or three times. For example, two structural units according to formula (SCC-1) may be linked to each other via a bridging group such as an alkylene group.

According to one preferred embodiment, the silanol condensation catalyst (SCC) is a sulfonic acid of the formula (SSC-1) or a precursor thereof:

Ar(SO₂OH)x (SSC-1),
wherein
Ar is an aryl group, preferably 1 to 3 aromatic rings, and more preferably 1 to 2 aromatic rings (e.g. benzene or naphthalene), and wherein the aryl group is optionally substituted by at least one (e.g. one to four) optionally substituted C1-C30-hydrocarbyl group, and preferably wherein the aryl group is substituted by at least one (e.g. one to four) C1-C30-hydrocarbyl group,
and
x is at least 1 (e.g. 1 to 3).

The at least one C1-C30 hydrocarbyl group is preferably at least one C4-C30 alkyl group, which can be branched or straight chained. For example, the at least one C4-C30 alkyl group can be one dodecyl group or four propyl groups.

According to one preferred embodiment, the silanol condensation catalyst (SCC) is a sulfonic acid of the formula (SSC-1) or a precursor thereof:

Ar(SO₂OH)x (SSC-1),
wherein
Ar is benzene or a naphthalene, which is substituted by at least one (e.g. one to four) C4-C30 alkyl group, and
x is at least 1 (e.g. 1 to 3), and optionally is 1.

The currently most preferred compounds of formula (SCC-1) are dodecyl benzene sulfonic acid, tetrapropyl benzene sulfonic acid and naphthalene-based sulfonic acids, such as C₁₂-alkylated naphthyl sulfonic acids.

Furthermore, the sulfonic acid can have from 10 to 200 carbon atoms, and preferably from 14 to 100 carbon atoms. According to a preferred embodiment, the sulfonic acid comprises 10 to 200 carbon atoms, preferably 14 to 100 carbon atoms, and the sulfonic acid further comprises at least one (e.g. one) aromatic group like a benzene.

The silanol condensation catalyst (SCC) may also be a precursor of a sulfonic acid, i.e. a compound that is converted by hydrolysis to a sulfonic acid. Such a precursor is, for example, the corresponding acid anhydride of the sulfonic acid, and preferably of the sulfonic acid according to formula (SCC-I). Another example of such a precursor is a sulfonic acid, and preferably the sulfonic acid according to formula (SCC-I), that has been provided with a hydrolysable protective group as for example an acetyl group, which can be removed by hydrolysis to provide the sulfonic acid.

### Scorch Retardant Additive (SRA)

The polymer composition (PC) comprises a scorch retardant additive (SRA) as a component (d).

The scorch additive (SRA) can, for example, be present in the polymer composition (PC) in an amount of in the range of 0.5 to 5.0 wt. %, preferably 1.0 to 4.5 wt. %, more preferably 1.5 to 4.0 wt. %, and still more preferably 2.0 to 3.5 wt. %, based on the total weight of the polymer composition (PC).

Scorch retardant additives are known in the art. Scorch retardant additives are usually added to curable or cross-linkable polymer composition to prevent premature curing or scorching of said polymer compositions during processing.

The scorch retardant additive (SRA) is preferably a scorch retardant additive (SRA) which is suitable for retarding the scorching and/or cross-linking of a polymer containing hydrolysable silane groups, and preferably a polyolefin containing hydrolysable silane groups, and more preferably a polyethylene containing hydrolysable silane groups. According to one embodiment, the scorch retardant additive (SRA) is an organic silane comprising at least one Si—O bond.

According to one embodiment, the scorch retardant additive (SRA) is an alkoxy-substituted silane. The one or more alkoxy substituents of the scorch retardant additive can react with water so as to scavenge moisture and thereby to prevent premature curing of a cross-linkable silane containing polymer.

The scorch retardant additive (SRA) can also be a compound which comprises more than one alkoxy-substituted silanes like two or three alkoxy-substituted silanes. For example, the scorch retardant additive (SRA) can comprise bis- or tris-(trialkoxy)silyl groups.

It is further preferred that the scorch retardant additive (SRA) is an alkoxy-substituted and hydrocarbyl-substituted silane. The one or more hydrocarbyl substituents, preferably one or more alkyl substituents, can increase compatibility of the scorch retardant additive with a polymer matrix.

According to one preferred embodiment, the scorch retardant additive (SRA) is a silane of the formula (SRA-1):

Si(R¹)n(R²)m (SRA-1),
wherein
n is 1 to 3 and m is 1 to 3 with the proviso that n+m=4,
R¹ is an optionally substituted C5-C30 hydrocarbyl group, or, if n is more than 1, is each independently an optionally substituted C5-C30 hydrocarbyl group,
R² is an optionally substituted C1-C6 alkoxy group, or, if m is more than 1, is each independently an optionally substituted C1-C6 alkoxy group.

Preferably, n of formula (SRA-1) is 1 or 2, and more preferably 1.

Preferably, m of formula (SRA-1) is 2 or 3, and more preferably 3.

Preferably, R¹ of formula (SRA-1) is a branched or straight chained C5-C30 alkyl group, more preferably a branched or straight chained C5 to C25 alkyl group, and still more preferably a C8-C20 straight chained alkyl group, like a C16 straight chain alkyl group. Preferably, R2 of formula (SRA-2) is a C1-C6 alkoxy group, more preferably a C1-C4 alkoxy group, and still more preferably methoxy or ethoxy.

The scorch retardant additive may also be a compound having the structure according to formula (SRA-2):

(R^{1a})_{f}[Si(R^{2a})_{g}(R^{3a})ₕ]ₗ (SRA-2),
wherein
R^{1a}, which may be the same or different if more than one such group is present, is a monofunctional, or, if i=2, is a bifunctional, hydrocarbyl residue comprising from 1 to 100 carbon atoms;
R^{2a}, which may be the same or different if more than one such group is present, is a hydrocarbyloxy residue comprising from 1 to 100 carbon atoms;
R^{3a}, is —R^{4a}SiR^{1a}ₚR^{2a}_{q}, wherein p is 0 to 3, q is 0 to 3, with the proviso that p+q is 3, and R^{4a} is —(CH₂)ᵣYₛ(CH₂)ₜ— where r and t independently are 1 to 3, s is 0 or 1 and Y is a difunctional heteroatomic group selected from —O—, —S—, —SO—, —SO₂—, —NH—, —NR^{1a}— or —PR^{1a}—; and f is 0 to 3, g is 1 to 4, h is 0 or 1, with the proviso that f+g+h=4;
and i=1 or 2.

The compound according to formula (SRA-2) is also described in WO 2007/137757 (cf. compound (C) of formula (I) in claim 1). Embodiments and preferred embodiments of compound (C) of formula (I) as defined in WO 2007/137757 are incorporated herein by reference.

### Antioxidant (AO) and Additional Additives (AD-1)

The polymer composition (PC) preferably comprises an antioxidant (AO) as a component (e). The antioxidant (AO) can be one antioxidant or more than one antioxidant such as a mixture of antioxidants.

The antioxidant can, for example, be present in the polymer composition (PC) in an amount in the range of 0.1 to 8.0 wt. %, preferably 0.5 to 7.0 wt. %, more preferably 3.0 to 7.0 wt. %, and still more preferably 4.0 to 6.5 wt. %, based on the total weight of the polymer composition (PC).

The antioxidant can be selected by the skilled person, and is preferably a polar antioxidant. Preferably, the antioxidant is an antioxidant which is suitable for use in a cross-linkable polymer composition, and more preferably in a cross-linkable polymer composition which comprises a polyolefin containing hydrolysable silane groups. More preferably, the antioxidant (AO) is at least one antioxidant selected from the group of sterically hindered phenols. Such compounds are known in the art and, for example, described in described in “Plastic Additives Handbook”, 6th edition 2009 of Hans Zweifel (pages 1141 to 1190).

Furthermore, the polymer composition (PC) can comprise one or more additional additives (AD-1). Additional additives can be, but are not limited to, metal deactivators, metal passivator, acid scavengers, colorants, light stabilisers, plasticizers, slip agents, anti-scratch agents, dispersing agents, processing aids, lubricants, pigments (e.g. carbon black), fillers, and the like. Such additives are commercially available and for example described in “Plastic Additives Handbook”, 6th edition 2009 of Hans Zweifel (pages 1141 to 1190).

A suitable optional additive (AD-1) is, for example, carbon black. Thus, the polymer composition (PC) can comprise one or more additional additives (AD-1), which at least comprise carbon black.

Preferably, the polymer composition (PC) comprises one or more additional additives (AD-1), which at least comprise a processing aid, and preferably wherein the processing aid is a wax. More preferably, the polymer composition (PC) comprises one additional additive (AD-1), which is a processing aid, like a wax.

### Use of the Polymer Composition (PC)

One aspect of the invention provides the use of a polymer composition (PC) as defined herein as a silanol condensation catalyst masterbatch for the preparation of a cross-linkable polymer composition.

One embodiment of the invention relates to the use of a polymer composition (PC) as defined herein for the preparation of a cross-linkable polymer composition.

Thus, the polymer composition (PC) of the invention can be used to add a silanol condensation catalyst to a cross-linkable polymer composition and/or mix a silanol condensation catalyst with a cross-linkable polymer composition.

The polymer composition (PC) can be used in an amount of in the range of 0.5 to 15.0 wt. %, preferably 1.0 to 10.0 wt. %, and more preferably 2.0 to 7.5 wt. %, like in the range of 2.5 to 6.0 wt. %, based on the total weight of the cross-linkable polymer composition.

One embodiment of the invention relates to a process for preparing a cross-linkable polymer composition, wherein the process comprises the step of mixing a polymer composition (PC) according to the invention with a cross-linkable polyolefin, and preferably a cross-linkable polyolefin comprising hydrolysable silane groups.

### Cross-Linkable Polymer Composition (CL-PC)

One aspect of the invention provides a cross-linkable polymer composition (CL-PC) which comprises
(i) the polymer composition (PC) as defined herein, and
(ii) a cross-linkable polyolefin (CL-PO) which comprises hydrolysable silane groups.

The cross-linkable polymer composition (CL-PC) preferably comprises, more preferably consists of,
(i) 0.5 to 15.0 wt. % of the polymer composition (PC), preferably 1.0 to 10.0 wt %, and more preferably 2.0 to 7.5 wt %, like in the range of 2.5 to 6.0 wt. %,
(ii) 85.0 to 99.5 wt. % of the cross-linkable polyolefin (CL-PO), preferably 90.0 to 99.9 wt. %, and more preferably 92.5 to 98.0 wt. %, like in the range of 94.0 to 97.5 wt. %,
wherein all weight amounts are based on the total weight of the cross-linkable polymer composition (PC), and preferably wherein the components (i) and (ii) add up to 100 wt. %.

It is also possible that the cross-linkable polymer composition (CL-PC) comprises further polymeric materials in addition to the cross-linkable polyolefin (CL-PO), the polyethylene (PE) and the ethylene (meth)acrylate copolymer (EAC). The cross-linkable polymer composition (CL-PC) may also comprise further additives (AD-2) in addition to the additives being present in the polymer composition (PC).

According to one embodiment, the cross-linkable polymer composition (CL-PC) comprises, preferably consists of,
(i) 0.5 to 10.0 wt. % of the polymer composition (PC),
(ii) 80.0 to 99.4 wt. % of the cross-linkable polyolefin (CL-PO), and
(iii) 0.1 to 10.0 wt. % of materials selected from
   (a) polymers other than the cross-linkable polyolefin (CL-PO), the polyethylene (PE) and the ethylene (meth)acrylate copolymer (EAC), and
   (b) additives (AD-2),
      wherein all weight amounts are based on the total weight of the cross-linkable polymer composition (PC), and preferably wherein the components (i) to (iii) add up to 100 wt. %.

The additives (AD-2) may be, but are not limited to, acid scavengers, antioxidants, colorants, light stabilisers, plasticizers, slip agents, anti-scratch agents, dispersing agents, processing aids, lubricants, pigments, and the like. Such additives are commercially available and for example described in “Plastic Additives Handbook”, 6th edition 2009 of Hans Zweifel (pages 1141 to 1190).

The cross-linkable polymer composition (CL-PC) can have specific properties such as a specific scorch rating.

The scorch rating as used herein has a rating scale from 1 to 5, wherein a rating of 1 indicates that a heat-treated polymer composition (PC) shows no or very little scorch (i.e. the best rating), and wherein a rating of 5 indicates that the heat-treated polymer composition shows much scorch (i.e. the worst rating). According to one embodiment, the polymer composition (PC) has a scorch rating determined according to the method described herein above under “Method—Scorch test” of 1 or 2.

The cross-linkable polymer composition is preferably cross-linkable at a temperature of 5 to 50° C., more preferably of 10 to 40° C. and a relative humidity below 85%, more preferably below 75%.

### Polymer Composition (PC)

The cross-linkable polymer composition (CL-PC) comprises a polymer composition (PC) as defined herein above. The embodiments and preferred embodiments of the polymer composition (PC) are also disclosed herein in combination with the cross-linkable polymer composition (CL-PC).

### Cross-Linkable Polyolefin (CL-PO)

The cross-linkable polymer composition (CL-PC) comprises a cross-linkable polyolefin (CL-PO). The cross-linkable polyolefin (CL-PO) comprises hydrolysable silane groups.

Preferably, the cross-linkable polyolefin (CL-PO) is a polyethylene comprising hydrolysable silane groups. The hydrolysable silane groups may be introduced into the polyolefin, preferably polyethylene, by copolymerization of, for example, ethylene monomers with silane group containing comonomers. Alternatively, the hydrolysable silane groups may be introduced into the polyolefin by grafting, i.e. by chemical modification of the polymer by addition of silane groups mostly in a radical reaction. Both techniques are well known in the art.

Hence, according to one embodiment, the cross-linkable polyolefin (CL-PO), preferably cross-linkable polyethylene, is obtained or is obtainable by copolymerization of ethylene and a silane compound as comonomer. Alternatively, the cross-linkable polyolefin (CL-PO), preferably cross-linkable polyethylene, is obtained or is obtainable by grafting a polyolefin, preferably polyethylene, with a silane compound. Preferably, the cross-linkable polyolefin (CL-PO) is obtained or is obtainable by copolymerization.

The copolymerization is preferably carried out with an unsaturated silane compound as comonomer represented by the formula (I)

R^{1b}SiR^{2b}_{q}Y_{3-q} (I),
wherein
R^{1b} is an ethylenically unsaturated hydrocarbyl, hydrocarbyloxy or (meth)acryloxy hydrocarbyl group,
R^{2b} is an aliphatic saturated hydrocarbyl group,
Y which may be the same or different, is a hydrolysable organic group and
q is 0, 1 or 2.

Examples of the unsaturated silane compound are those wherein
R^{1b} is vinyl, allyl, isopropenyl, butenyl, cyclohexanyl or gamma-(meth)acryloxy propyl;
Y is methoxy, ethoxy, formyloxy, acetoxy, propionyloxy or an alkyl- or arylamino group; and
R^{2b}, if present, is a methyl, ethyl, propyl, decyl or phenyl group.

A preferred unsaturated silane compound is represented by the formula (II)

CH₂═CHSi(OA)ₐ (II),
wherein
A is a hydrocarbyl group having 1-8 carbon atoms, preferably 1-4 carbon atoms, and a is 3.

More preferred compounds are vinyl trimethoxysilane, vinyl bismethoxyethoxysilane, vinyl triethoxysilane, gamma-(meth)acryl-oxypropyl-trimethoxysilane, gamma(meth)acryloxypropyl triethoxysilane, and vinyl triacetoxysilane, or combinations of two or more thereof.

The copolymerization of the olefin, for example ethylene, and the unsaturated silane compound may be carried out under any suitable conditions resulting in the copolymerization of the two monomers.

The cross-linkable polyolefin (CL-PO) is preferably a low density polyethylene comprising hydrolysable silane groups. Ethylene monomers and the hydrolysable silane group comonomers are preferably copolymerized in a high pressure process as known in the art.

Preferably, the cross-linkable polyolefin (CL-PO) has a silane comonomer content in an amount of 0.001 wt. % or more, more preferably 0.01 wt. % or more, even more preferably 0.1 wt %, and most preferably 0.4 wt. % or more, based on the total weight of the cross-linkable polyolefin (CL-PO). Preferably, the cross-linkable polyolefin (CL-PO) has a silane comonomer content in an amount of 15.0 wt. % or less, more preferably 5.0 wt. % or less, even more preferably 2.5 wt. % or less, and most preferably 1.5 wt. % or less, based on the total weight of the cross-linkable polyolefin (CL-PO).

Preferably, the cross-linkable polyolefin (CL-PO) has a silane comonomer content in an amount of 0.001 to 15.0 wt. %, more preferably 0.01 to 5.0 wt. %, even more preferably 0.1 to 2.5 wt. % and most preferably 0.4 to 1.5 wt %, based on the total weight of the cross-linkable polyolefin (CL-PO).

More preferably, the cross-linkable polyolefin (CL-PO) is a low density polyethylene having a silane comonomer content in an amount of 0.001 to 15.0 wt. %, more preferably 0.01 to 5.0 wt. %, even more preferably 0.1 to 2.5 wt. % and most preferably 0.4 to 1.5 wt. %, based on the total weight of the cross-linkable polyolefin (CL-PO).

Preferably, the cross-linkable polyolefin (CL-PO) has an MFR₂ (190° C., 2.16 kg) of 0.1 to 200 g/10 min, more preferably of 0.3 to 50 g/10 min and most preferably of 0.5 to 10 g/10 min. Preferably, the cross-linkable polyolefin (CL-PO) has a density of 850 to 960 kg/m³, more preferably of 860 to 945 kg/m³ and most preferably of 880 of 935 kg/m³.

More preferably, the cross-linkable polyolefin (CL-PO) has an MFR₂ (190° C., 2.16 kg) of 0.1 to 200 g/10 min, even more preferably of 0.3 to 50 g/10 min and most preferably of 0.5 to 10 g/10 min, and has a density of 850 to 960 kg/m³, even more preferably of 860 to 945 kg/m³ and most preferably of 880 of 935 kg/m³.

### Article

In one aspect, the invention provides an article comprising the cross-linkable composition (CL-PC) according to the invention.

Preferably, the cross-linkable composition (CL-PC) is present in the article in cross-linked form. Hence, in one embodiment, an article is provided which comprises the cross-linkable composition (CL-PC) according to the invention, and wherein the cross-linkable polymer composition (CL-PC) is cross-linked. Preferably, the cross-linked polymer composition comprises siloxane (i.e. —Si—O—Si—) cross-linking units.

In one preferred embodiment, the article is a cable, and preferably a low voltage cable. Designs of low voltages cables are inter alia described in standards HD 603 and IEC 60502-1.

Preferably the cable comprises at least one layer comprising the cross-linkable polymer composition (CL-PC) according to the invention. The at least one layer may be at least one insulation layer of the cable.

The insulation layer can have a thickness of in the range of 0.1 to 5.0 mm, preferably 0.25 to 4.0 mm, more preferably of 0.4 to 3.0 mm, and even more preferably of 0.5 to 2.3 mm.

The cable as defined herein can be produced by co-extrusion of the at least one layer onto the conducting core. Then, cross-linking of the cross-linkable polymer composition is performed by moisture curing, wherein in the presence of the silanol condensation catalyst the silane groups of the cross-linkable polyolefin are hydrolyzed under the influence of water or steam, resulting in the splitting off of alcohol and the formation of silanol groups, which are then cross-linked in a condensation reaction wherein water is split off.

Moisture curing may be performed in a sauna or water bath at temperatures of 70 to 100° C. In a preferred embodiment, the curing is performed at a temperature of 5 to 50° C., more preferably of 10 to 40° C. and a humidity below 85%, more preferably below 75%.

### Examples

The following definitions of terms and determination methods apply for the above general description of the invention as well as to the below examples unless otherwise defined.

### Methods

### Melt Flow Rate

The melt flow rate (MFR) was determined according to ISO 1133 and is indicated in g/10 min. The MFR is an indication of the flowability, and hence the processability of the polymer. The higher the melt flow rate, the lower the viscosity of the polymer.

The MFR₂ of polyethylene (co-)polymers was measured at a temperature of 190° C. and at a load of 2.16 kg.

### Density

Density of the polymer was measured according to ISO 1183-1:2004 Method A on compression moulded specimen prepared according to EN ISO 1872-2 and is given in kg/m³.

### Scorch Rating Test

The scorch rating test was used to evaluate how much scorch is formed in a cross-linkable polymer composition comprising an inventive or a comparative polymer composition (PC), in case the polymer composition is exposed to processing conditions which are more drastic (e.g. higher temperature) than the usual processing condition.

For the scorch rating test, the material was processed through tape extrusion at high temperature (210° C.). A 0.2 to 0.3 mm thin tape was formed as described below and the tape surface was visually inspected and rated from 1 (close to no scorch) to 5 (very high amounts of scorch). Tape extrusion was conducted on a Collin Teach-line extruder E20T R1603 with a die of 0.5 mm is used with Visico LE4423 (cross-linkable polyethylene commercially available from Borealis AG) and 5% of the inventive or comparative polymer composition (PC) according to the examples below. The components were dry blended prior to extrusion. The extruder was run with the following temperature profile: 60/160/180/210/210/210° C. for at least 30 min.

### Aggregation Test

The inventive and comparative polymer composition (PC) according to the examples below were kept in a closed aluminum bag at 50° C. at 50% relative humidity in a climate oven. The samples stored in the bags were evaluated for aggregation after certain time periods, such as 1, 2 and 3 months. The pellets were rated according to their aggregation state, where the rating of 1 indicates that all pellets form a lump and no pellets are free flowing anymore, whereas a rating of 5 means free flowing pellets.

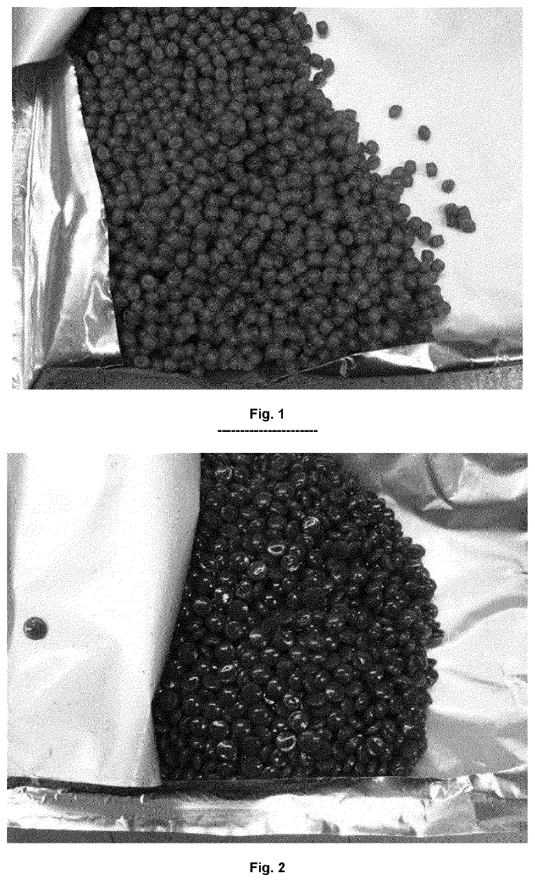

FIG. 1 shows an example of a pellets having an aggregation rating of 4-5 according to the aggregation test as described herein.

FIG. 2 shows an example of pellets having an aggregation rating of 1 according to the aggregation test as described herein. All pellets form a lump and no pellets are free flowing anymore.

### RADIAL SHRINKAGE

Radial shrinkage was optically evaluated on cable drums after at least 14 days. Cables were prepared from some of the polymer compositions according to Table 1.

Loose cables on the drum are a sign of radial shrinkage. Tight cable strains on the drum are indicating no radial shrinkage. The cables were classified in Table 1 as (+): when no radial shrinkage was observed and (−) when radial shrinkage was observed.

### Materials

### Polyethylene (PE1)

Polyethylene (PE1) is a low density polyethylene homopolymer, which is commercially available from Borealis as MA8200; it has a density of 920 kg/m³ and a melt flow rate (ISO 1133; 2.16 kg; 190° C.) of 7.5 g/10 min.

### Ethylene Acrylate Copolymer (EAC1)

Ethylene acrylate copolymer (EAC1) is an ethylene butyl acrylate copolymer which has a butyl acrylate comonomer content of 17.0 wt. %, (MFR₂ 190° C.=8.00 g/10 min, density 925.5 kg/m³) based on the total weight of EAC1, which was produced as follows.

Fresh ethylene and recycled ethylene and comonomer butyl acrylate was compressed to reach an initial reactor pressure of 2500 bars in two parallel streams to supply the front and the side of a split feed 2 zone reactor with a varying L/D between around 17300 to 30400. Butyl acrylate comonomer was added in amounts to reach 17 wt.-% in the final polymer. An MFR₂ of the final polymer of 8.00 g/10 min was maintained. After compression, the front stream was heated to 151° C. in a preheating section before entering the front zone of the reactor and the side stream was cooled and entered at the side of the reactor. Mixtures of commercially available peroxide radical initiators dissolved in an essentially inert hydrocarbon solvent were injected after the preheating section and at one more position along the reactor in amounts sufficient for the exothermal polymerization reaction to reach peak temperatures of 275° C., and 260° C. respectively, with cooling in-between to 170° C. The reaction mixture was depressurised by a pressure control valve, cooled and the polymer was separated from unreacted gas.

### Silanol Condensation Catalyst (SCC1)

The silanol condensation catalyst (SCC1) is linear dodecylbenzene sulfonic acid (DDBSA), commercially available from Unger Fabrikker under the tradename Ufacid K.

### Scorch Retardant Additive (SRA1)

The scorch retardant additive (SRA1) is hexadecyl trimethoxy silane (HDTMS), commercially available from Wacker.

### Antioxidant (AO1) and Processing Aid (PA1)

The antioxidant (AO1) is a sterically hindered phenol. The processing aid (PA1) is a wax.

### Cross-Linkable Polyolefin (CL-PO1)

The cross-linkable polyolefin (CL-PO1) is a silane group containing low density polyethylene having a density of 923 kg/m³, a MFR₂ of 1 g/10 min and a vinyl trimethyl silane (VTMS) copolymer content of 0.072 mol kg/polymer (=1.1 wt. % based on the total weight of the copolymer produced according to the conditions disclosed for inventive example 2 (polymer D) according to EP 2 508 566 A1.

### Examples

Polymer compositions (PC) were prepared by compounding components PE1, EAC1, SCC1, SRA1, AO1 and PA1 using a Brabender kneader.

Inventive and comparative polymer compositions (PC) are shown in Table 1 below.

TABLE 1
Composition of inventive and comparative polymer compositions.

| Component | | CE1 | CE2 | CE3 | IE1 | IE2 | IE3 |
|---|---|---|---|---|---|---|---|
| PE1 | [wt. %] | 89.6 | — | 88.1 | 78.1 | 63.1 | 44.1 |
| EAC1 | [wt. %] | — | 88.1 | — | 10.0 | 25 | 44 |
| SCC1 | [wt. %] | 1.5 | 1.5 | 1.5 | 1.5 | 1.5 | 1.5 |
| SRA1 | [wt. %] | 1.5 | 3.0 | 3.0 | 3.0 | 3.0 | 3.0 |
| AO1 | [wt. %] | 6.4 | 6.4 | 6.4 | 6.4 | 6.4 | 6.4 |
| PA1 | | 1.0 | 1.0 | 1.0 | 1.0 | 1.0 | 1.0 |
| Properties | | | | | | | |

| | | | | | | |
|---|---|---|---|---|---|---|
| Scorch rating | 4 | 1 | 3 | 2 | 2 | 2 |
| Aggregation rating | | | | | | |
| after 1 month | 3 | 4 | 1 | 2 | 4 | 4 |
| after 2 months | 2 | 4 | 1 | 3 | 4 | 4 |
| after 3 months | 1 | 4 | 1 | 3 | 3 | 4 |
| Radial Shrinkage | (+) | (−) | (+) | (n.d.) | (+) | (+) |

n.d. = not determined.

As can be seen from the result in table 1, the comparative polymer compositions CE1 to CE3 either show high scorching or aggregate readily within a given storage time. In contrast thereto, the inventive compositions IE1 to IE3 combine a good scorch rating with little to no aggregation. Furthermore, the inventive examples show excellent radial shrinkage behavior, whereas CE2 without PE1 is not performing well in the radial shrinkage test.

1. A polymer composition (PC) comprising
(a) a polyethylene (PE), which does not contain hydrolysable silane groups,
(b) an ethylene (meth)acrylate copolymer (EAC),
(c) a silanol condensation catalyst (SCC), and
(d) a scorch retardant additive (SRA).

2. The polymer composition (PC) according to claim 1, wherein the polymer composition (PC) comprises the polyethylene (PE) and the ethylene (meth)acrylate copolymer (EAC) in a weight ratio of 95:5 to 20:80.

3. The polymer composition (PC) according to claim 1, wherein the polymer composition (PC) comprises:
(a) 30.0 to 94.0 wt. % of the polyethylene (PE),
(b) 5.0 to 60.0 wt of the ethylene (meth)acrylate copolymer (EAC),
(c) 0.5 to 8.0 wt. % of the silanol condensation catalyst (SCC), and
(d) 0.5 to 5.0 wt. % of the scorch retardant additive (SRA), and
(e) optionally 0.1 to 8.0 wt. % of an antioxidant (AO),
(f) optionally 0.1 to 5.0 wt. % of one or more additional additives (AD-1),
wherein all weight contents are based on the total weight of the polymer composition (PC), and optionally wherein the components (a) to (f) add up to 100 wt. %.

4. The polymer composition (PC) according to claim 1, wherein the polyethylene (PE) is a low density polyethylene (LDPE), and/or wherein the polyethylene (PE) is a polyethylene homopolymer.

5. The polymer composition (PC) according to claim 1, wherein the ethylene (meth)acrylate copolymer (EAC) is a copolymer of ethylene and at least one comonomer selected from C1-C6 hydrocarbyl (meth)acrylates, preferably is a copolymer of ethylene and at least one comonomer selected from C1-C6 hydrocarbyl acrylates, and more preferably is a copolymer of ethylene and one comonomer selected from C1-C6 hydrocarbyl acrylates.

6. The polymer composition (PC) according to claim 1, wherein the ethylene (meth)acrylate copolymer (EAC) has a (meth)acrylate comonomer content in the range of 5.0 to 25.0 wt. % based on the total weight of the ethylene (meth)acrylate copolymer (EAC).

7. The polymer composition (PC) according to claim 1, wherein the silanol condensation catalyst (SCC) is a sulfonic acid.

8. The polymer composition (PC) according to claim 1, wherein the silanol condensation catalyst (SCC) is a sulfonic acid of the formula (SSC-1) or a precursor thereof:
Ar(SO₂OH)x (SSC-1),
wherein
Ar is an aryl group, which is optionally substituted by at least one optionally substituted C1-C₃₀-hydrocarbyl group, and
x is at least 1.

9. The polymer composition (PC) according to claim 1, wherein the scorch retardant additive (SRA) is an organic silane comprising at least one Si—O bond.

10. The polymer composition (PC) according to claim 1, wherein the scorch retardant additive (SRA) is a silane of the formula (SRA-1):
Si(R¹)n(R²)m (SRA-1),
wherein
n is 1 to 3 and m is 1 to 3 with the proviso that n+m=4,
R¹ is an optionally substituted C5-C30 alkyl group, or, if n is more than 1, is each independently an optionally substituted C5-C30 alkyl group,
R² is an optionally substituted C1-C6 alkoxy group, or, if m is more than 1, is each independently an optionally substituted C1-C6 alkoxy group.

11. The polymer composition (PC) according to claim 1, wherein the polymer composition (PC) has an aggregation rating determined according to the method described herein under “Method—aggregation test” of at least 3 after 3 months of storage at 50° C. and a relative humidity of 50%.

12. A method for preparing a cross-linkable polymer composition, wherein the method comprises the use of a polymer composition (PC) according to claim 1 as a silanol condensation catalyst masterbatch.

13. A cross-linkable polymer composition (CL-PC) comprising
(i) the polymer composition (PC) according to claim 1, and
(ii) a cross-linkable polyolefin (CL-PO) which comprises hydrolizable silane groups.

14. An article comprising the cross-linkable polymer composition (CL-PC) according to claim 13, wherein the cross-linkable polymer composition (CL-PC) is cross-linked.

15. The article according to claim 14, wherein the article is a cable.

16. The polymer composition (PC) according to claim 1, wherein the polymer composition (PC) comprises the polyethylene (PE) and the ethylene (meth)acrylate copolymer (EAC) in a weight ratio of 92:8 to 40:60.

17. The polymer_composition (PC) according to claim 1, wherein the polymer composition (PC) comprises the polyethylene (PE) and the ethylene (meth)acrylate copolymer (EAC) in a weight ratio of 80:20 to 40:60.

18. The polymer composition (PC) according to claim 1, wherein the polymer composition (PC) comprises the polyethylene (PE) and the ethylene (meth)acrylate copolymer (EAC) in a weight ratio of 70:30 to 40:60.

19. The polymer composition (PC) according to claim 1, wherein the polymer composition (PC) comprises:
(a) 40.0 to 85.0 wt. % of the polyethylene (PE),
(b) 8.0 to 55.0 wt. % of the ethylene (meth)acrylate copolymer (EAC),
(c) 0.8 to 6.0 wt. % of the silanol condensation catalyst (SCC), and
(d) 1.0 to 4.5 wt. % of the scorch retardant additive (SRA), and
(e) optionally 0.5 to 7.0 wt. % of an antioxidant (AO),
(f) optionally 0.1 to 4.0 wt. % of one or more additional additives (AD-1),
wherein all weight contents are based on the total weight of the polymer composition (PC), and optionally wherein the components (a) to (f) add up to 100 wt. %.

20. The polymer composition (PC) according to claim 1, wherein the polymer composition (PC) comprises:
(a) 41.0 to 83.0 wt. % of the polyethylene (PE),
(b) 8.0 to 50.0 wt. % of the ethylene (meth)acrylate copolymer (EAC),
(c) 1.0 to 4.0 wt. % of the silanol condensation catalyst (SCC), and
(d) 1.5 to 4.0 wt. % of the scorch retardant additive (SRA), and
(e) optionally 3.0 to 7.0 wt. % of an antioxidant (AO),
(f) optionally 0.1 to 3.0 wt. % of one or more additional additives (AD-1),
wherein all weight contents are based on the total weight of the polymer composition (PC), and optionally wherein the components (a) to (f) add up to 100 wt. %.
